(19) United States
(12) Patent Application Publication
(10) Pub. No.: US 2019/0005521 A1
(43) Pub. Date: Jan. 3, 2019

(54) POINT-OF-SALE TERMINAL WITH QUESTIONNAIRE FUNCTION

(71) Applicant: TOSHIBA TEC KABUSHIKI KAISHA, Tokyo (JP)

(72) Inventor: Hironobu NOBE, Suita Osaka (JP)

(21) Appl. No.: 16/009,871

(22) Filed: Jun. 15, 2018

(30) Foreign Application Priority Data
Jul. 3, 2017 (JP) 2017-130283

(51) Int. Cl. G06Q 30/02; G06Q 20/20

(52) U.S. Cl. CPC G06Q 30/0203; G06Q 20/20

(57) ABSTRACT

According to an embodiment, a point-of-sale (POS) system includes a POS device, a commodity registration device, and a store server. The POS device includes a display device, an operation panel, a communication interface, a memory unit, and a processor. The communication interface receives commodity registration information for a transaction. The processor determines one or more questions relating to the transaction. The display device displays the one or more questions indicated by the questionnaire information and a plurality of answer choices for each question. A selection of one of the answer choices to each question is received via the operation panel. The processor performs a settlement processing of the transaction and generates corresponding settlement information. The memory unit stores answer information including: the settlement information, the received answers choices, and the commodity registration information in correspondence with each other. The communication interface transmits, to the store server, the answer information.

### CROSS TO REFERENCE TO RELATED APPLICATION

This application is based upon and claims the benefit of priority from Japanese Patent Application No. 2017-130283, filed Jul. 3, 2017, the entire contents of which are incorporated herein by reference.

### FIELD

Embodiments described herein relate generally to a point-of-sale terminal with questionnaire function.

### BACKGROUND

In the related art, a questionnaire is sometimes provided to a customer who purchased a commodity at a store. The content of the questionnaire is about a purchased commodity, about a response delivered by a clerk in charge of a register, and about the store. The customer fills in a questionnaire sheet, connects to the Internet using a mobile terminal, a PC, and the like, and answers the questionnaire. However, filling in the questionnaire form and connecting to the Internet are performed after accounting with respect to the purchased commodity is ended.

For that reason, the customer needs to fill in the questionnaire sheet at a separate place after the accounting is ended, or to connect to the Internet himself/herself and thus, an answer rate of the questionnaire is poor. Time has passed after the customer's shopping experience and thus, a questionnaire answer inevitably depends on past memory. Further, an intuitive answer from the customer may not be obtained.

### DESCRIPTION OF THE DRAWINGS

FIG. 1 is a diagram illustrating a system including a point-of-sale terminal according to an embodiment.

FIG. 2 is a diagram illustrating an exterior of a commodity information reading apparatus and a POS terminal according to the embodiment.

FIG. 3 is a block diagram illustrating a hardware configuration of the commodity information reading apparatus.

FIG. 4 is a diagram illustrating an example data structure stored in the commodity information reading apparatus.

FIG. 5 is a diagram illustrating another example data structure stored in the commodity information reading apparatus.

FIG. 6 is a block diagram illustrating a hardware configuration of the POS terminal.

FIG. 7 is a diagram illustrating an example of answer information transmitted from the POS terminal.

FIG. 8 is a block diagram illustrating a hardware configuration of a head office server.

FIG. 9 is a schematic diagram illustrating an example flow of data processed by the head office server.

FIG. 10 is a flowchart illustrating a flow of a control process of the commodity information reading apparatus.

FIG. 11 illustrates an example of a display on a display device of the commodity information reading apparatus.

FIG. 12 is a functional block diagram illustrating a functional configuration of the POS terminal.

FIG. 13 is a flowchart illustrating a flow of a control process of the POS terminal.

FIG. 14 illustrates an example of a display on a display device of the POS terminal.

FIG. 15 illustrates an example of another display on the display device of the POS terminal.

FIG. 16 is a flowchart illustrating a flow of a control process of the head office server.

### DETAILED DESCRIPTION

In general, according to one embodiment, there is provided a point-of-sale terminal and related method capable of obtaining an answer to a questionnaire in real time.

According to an embodiment, a point-of-sale (POS) device is used in a POS system that includes the POS device, a commodity registration device, and a store server. The POS device includes a customer display device positioned to display information to a customer, an operation panel, a communication interface, a memory unit, and a processor. The processor controls the communication interface to receive, from the commodity registration device, commodity registration information corresponding to commodities registered for purchase in a transaction, and determines whether the commodity registration information includes questionnaire information indicating one or more questions relating to the transaction to ask the customer. If the commodity registration information includes the questionnaire information, the processor controls the customer display device to display the one or more questions indicated by the questionnaire information and a plurality of answer choices for each question. The processor receives a selection of one of the answer choices to each question via the operation panel. The processor performs a settlement processing of the transaction based on the commodity registration information and generates corresponding settlement information. The processor controls the memory unit to store answer information including: the settlement information, the received answers choices (if any), and the commodity registration information in correspondence with each other. The processor controls the communication interface to transmit, to the store server, the answer information.

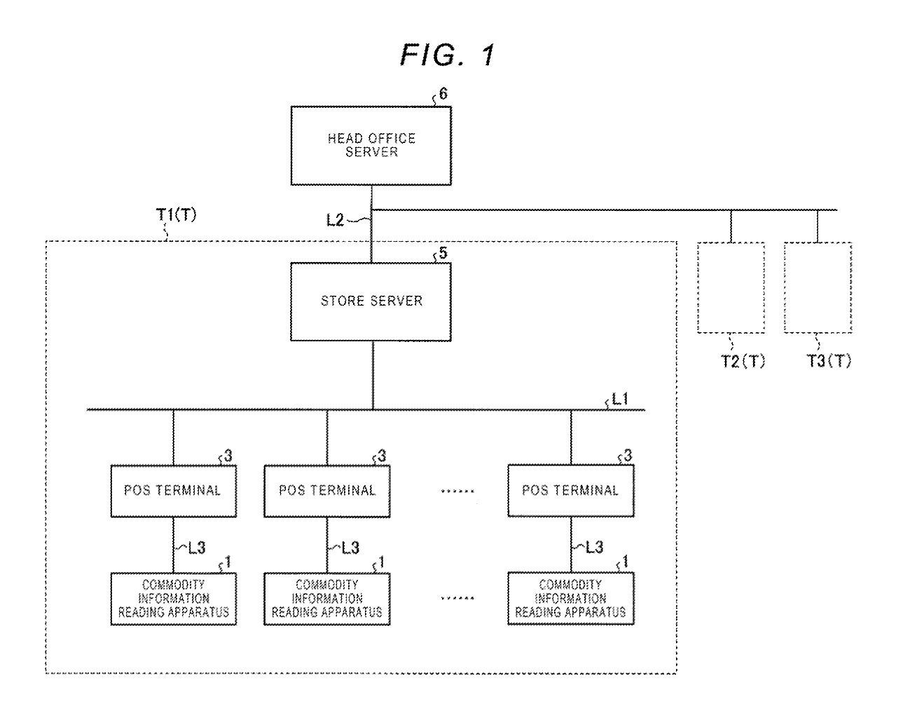

Hereinafter, a point-of-sale terminal and a program according to an embodiment will be described with reference to FIG. 1 to FIG. 16. In the embodiment, the POS terminal will be described as an example of an information processing apparatus. Exemplary embodiment is not limited by the embodiment described below.

FIG. 1 is a diagram illustrating a system according to an embodiment. The system includes a head office and a store T. The head office includes a head office server 6. The store T includes a store server 5, a POS terminal 3, and a commodity information reading apparatus 1.

The head office server 6 is connected to store servers 5 respectively provided at a plurality of stores T via a communication line L2. In the embodiment, three stores are illustrated: a store T1, a store T2, and a store T3. The communication line L2 is preferably a wireless or wired private network or public network provided between the head office server 6 and the store servers 5. The head office server 6 and the store server 5 can transmit and receive information and data to each other via the communication line L2. The head office server 6 is connected to a terminal device such as a portable terminal or a PC owned by a customer via, for example, an internet line (not illustrated).

The store server 5 is connected to a plurality of POS terminals 3 provided in the store T via a communication line L1. The communication line L1 is, for example, a LAN local area network (LAN). The store server 5 and the plurality of POS terminals 3 can transmit and receive information and data to each other via the communication line L1.

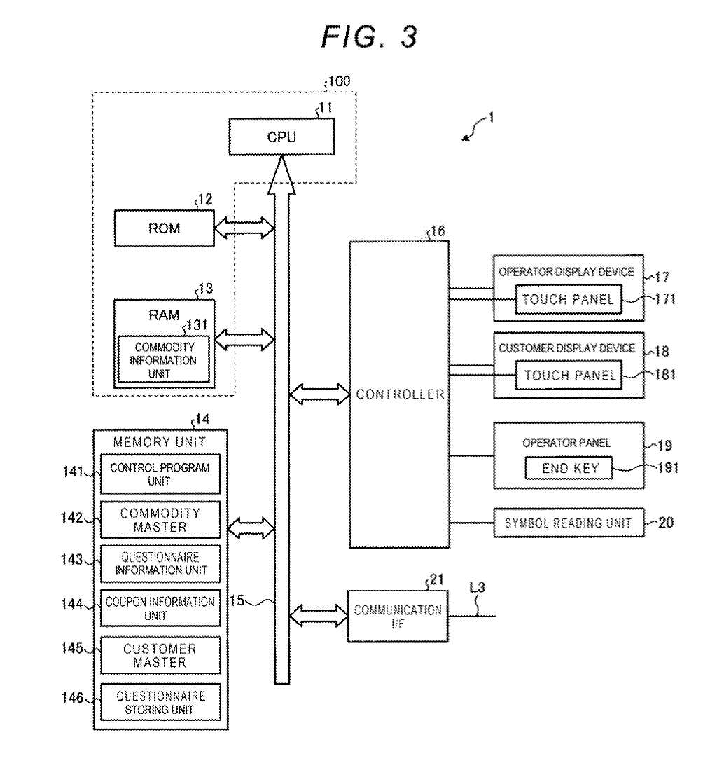

The commodity information reading apparatus 1 provided in the store T is connected to the POS terminal 3 via a communication line L3. One commodity information reading apparatus 1 is provided for each POS terminal 3. The commodity information reading apparatus 1 reads symbols such as a barcode and a two-dimensional code attached to a commodity, specifies the commodity, and executes a sales registration process. A sales registration process includes a process of displaying, based on the read symbols, commodity information such as a commodity name and price of the commodity corresponding to a commodity code (which specifies the commodity and is associated with the commodity) on an operator display device 17 and a customer display device 18 (see FIG. 3 for both) of the commodity information reading apparatus 1, and storing the commodity information.

The commodity information reading apparatus 1 displays a questionnaire related to a specific commodity determined in advance on the customer display device 18 when performing the sales registration process for the specific commodity. The customer answers the displayed questionnaire by operating a touch panel 181 provided on the customer display device 18.

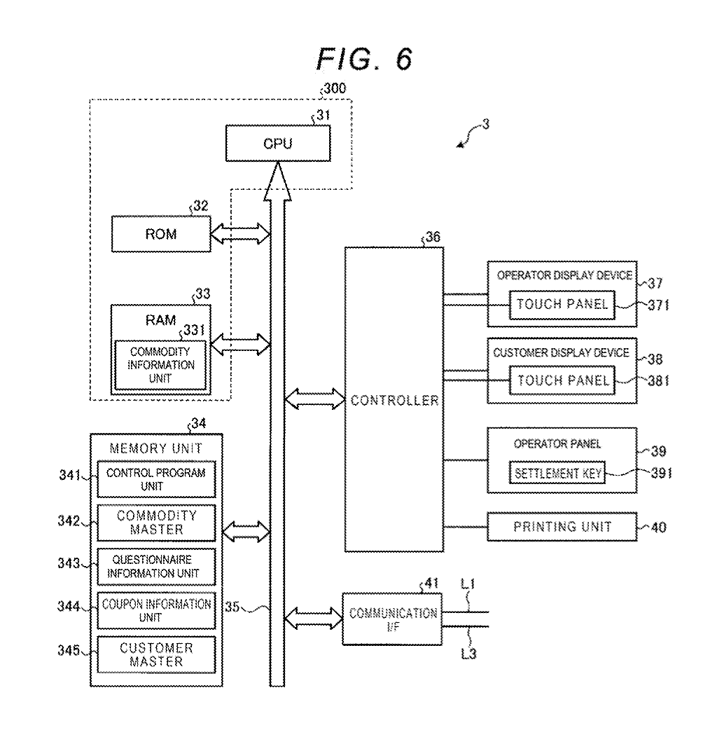

The POS terminal 3 executes a settlement process related to the transaction based on commodity information of the commodity subjected to a sales registration process by the commodity information reading apparatus 1. The settlement process includes a process of displaying a total amount, a deposit amount deposited from the customer, a change amount of the commodity subjected to the sales registration process on an operator display device 37 and a customer display device 38 (see FIG. 6 for both) of the POS terminal 3 and of storing the total amount, the deposit amount, and the change amount. The POS terminal 3 transmits stored commodity information and settlement information to the store server 5.

When transaction with the customer is ended, the POS terminal 3 displays the questionnaire related to the transaction and the store T on the customer display device 38. The customer answers the displayed questionnaire by operating the touch panel 381 provided in the customer display device 38. The POS terminal 3 transmits answer information associated with information related to the transaction to the store server 5.

The store server 5 stores commodity information, settlement information, and answer information received from each POS terminal 3. The store server 5 manages sales of the commodity at the store T based on the stored commodity information and settlement information. The store server 5 transmits the stored commodity information, settlement information, and answer information to the head office server 6 at predetermined timing (for example, once a day).

The head office server 6 aggregates and stores the commodity information, settlement information and answer information received from the store server 5. The head office server 6 analyzes the aggregated answer information. Based on the analysis result, the head office server 6 targets improving the store T and business operations, and clerk training. The head office server 6 utilizes the result as an order for ordering commodities or promotion information based on the analysis result. The head office server 6 transmits an email with appropriate content to the customer based on the analysis result.

In the stores T2 and T3, the same system as that of the store T1 is provided and a similar process is performed.

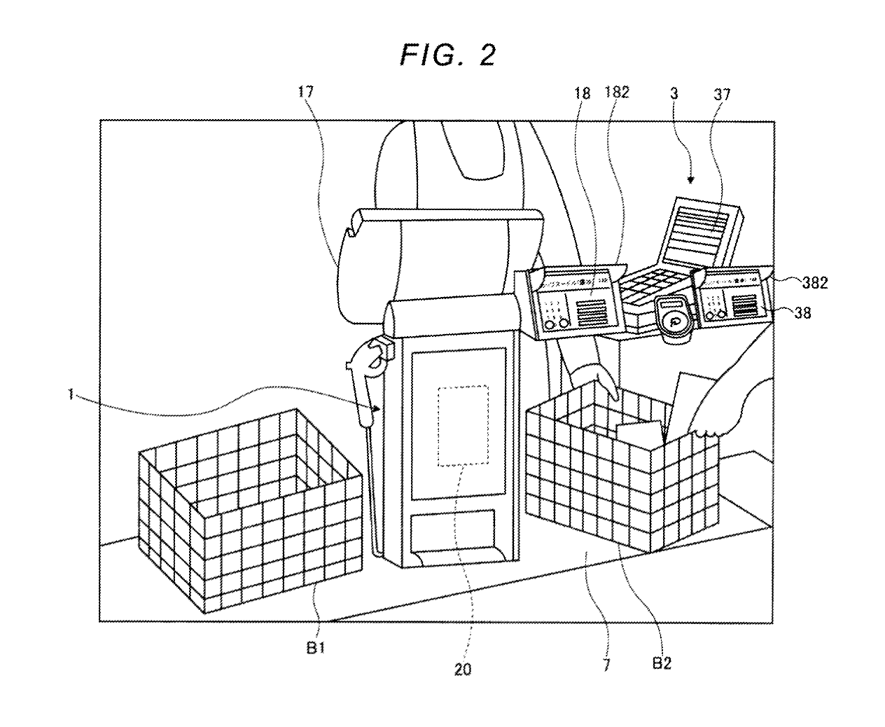

Next, the sales registration process and settlement process of the commodity will be described with reference to FIG. 2. In FIG. 2, the commodity information reading apparatus 1 is a vertical type scanner installed on a table 7, and is provided with a symbol reading unit 20 facing towards an operator. The commodity information reading apparatus 1 includes the operator display device 17 and the customer display device 18 on the upper unit of the symbol reading unit 20. The operator display device 17 includes a display screen facing the operator, and displays information to the operator. The customer display device 18 includes a display screen facing the customer, and displays information to the customer. Here, a mask 182 protruding in a U-shape on the customer side is provided on the upper unit of the customer display device 18. The mask 182 conceals information displayed on the customer display device 18 so that the information cannot be seen by other customers or operators.

The POS terminal 3 is provided on the downstream side of the commodity information reading apparatus 1 in the direction of approximately 90 degrees with the commodity information reading apparatus 1. The POS terminal 3 includes the operator display device 37 and the customer display device 38. The operator display device 37 includes a display screen facing the operator, and displays information to the operator. The customer display device 38 includes a display screen facing the customer, and information is displayed to the customer. Here, the mask 382 protruding in a U-shape on the customer side is provided on the upper unit of the customer display device 38. The mask 382 conceals information displayed on the customer display device 38 so that the information cannot be seen by other customers or operators.

The customer places a basket B1 containing the commodity to be purchased on the table 7. The operator performs an operation to take out one commodity from the basket B1, pass the front of a symbol reading unit 20, and put the commodity in a basket B2. The symbol reading unit 20 of the commodity information reading apparatus 1 optically reads the symbol attached to the passed commodity. Alternatively, the symbol reading unit 20 images and reads the symbol attached to the passed commodity. The commodity information reading apparatus 1 analyzes the read symbol, acquires a commodity code specifying the commodity, and executes a sales registration process related to the commodity. The operator repeats the same operation for all commodities in the basket B1.

When the symbol of the specific commodity is read, the commodity information reading apparatus 1 displays a questionnaire on the specific commodity and a plurality of answer choices on the customer display device 18. The customer answers the questionnaire by touching one of the answer choices (touching touch panel 181) for the questionnaire displayed on the customer display device 18.

When an end key 191 (see FIG. 3) for declaring the end of the sales registration process in the commodity information reading apparatus 1 is operated, information of the commodity registered for sales related to the transaction is transmitted to the POS terminal 3. When a settlement operation is executed in the POS terminal 3, a questionnaire related to the transaction or store is displayed on the customer display device 38. The customer answers to the questionnaire by touching one of the plurality of answer choices (touching touch panel 381) of the questionnaire displayed on the customer display device 38.

Next, a hardware configuration of the commodity information reading apparatus 1 will be described. FIG. 3 is a block diagram illustrating a hardware configuration of the commodity information reading apparatus 1. As illustrated in FIG. 3, the commodity information reading apparatus 1 includes a central processing unit (CPU) 11, a read only memory (ROM) 12, a random access memory (RAM) 13, a memory unit 14, and the like. The CPU 11 controls various components. The ROM 12 stores various programs. The RAM 13 develops various pieces of data. The memory unit 14 stores various programs. The CPU 11, the ROM 12, the RAM 13, and the memory unit 14 are connected to each other via a data bus 15. The CPU 11, the ROM 12, and the RAM 13 function as a control unit 100. That is, the control unit 100 executes a control process to be described later when the CPU 11 operates according to the control program stored in the ROM 12 and the memory unit 14 and developed in the RAM 13.

The RAM 13 includes a commodity information unit 131. The commodity information unit 131 stores commodity information of the commodity subjected to the sales registration process performed by the commodity information reading apparatus 1. The commodity information unit 131 stores an answer in association with questionnaire information that specifies a questionnaire.

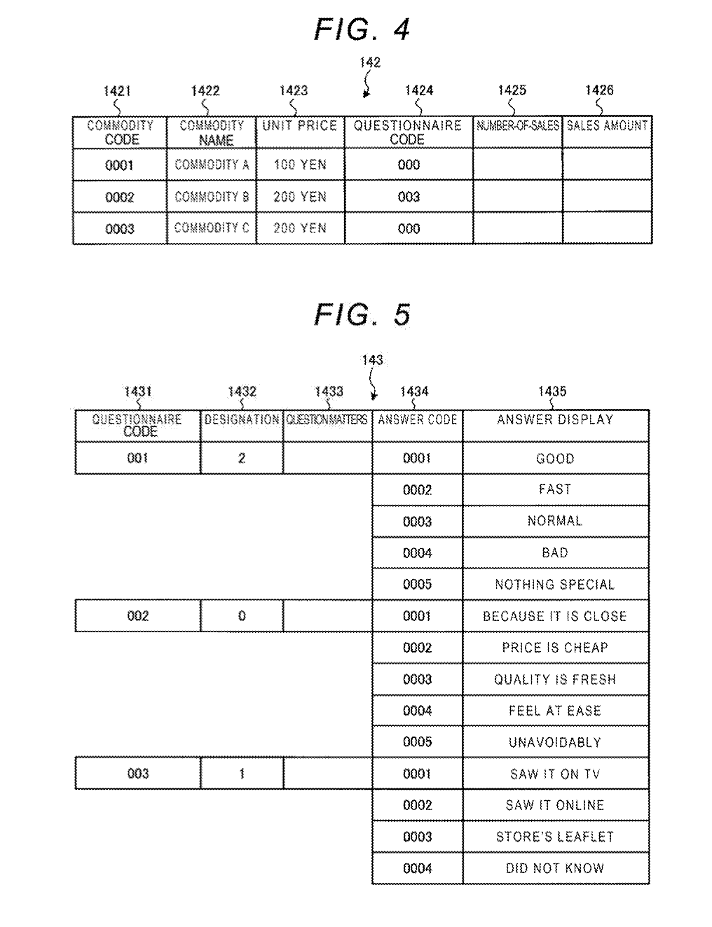

The memory unit 14 includes a control program unit 141, a commodity master 142, a questionnaire information unit 143, a coupon information unit 144, a customer master 145, and a questionnaire storing unit 146. The control program unit 141 stores a program for controlling a process of the commodity information reading apparatus 1. The commodity master 142 stores commodity information (commodity name, price, and the like) of the commodity in association with a commodity code specifying the commodity. The commodity master 142 will be described later with reference to FIG. 4.

The questionnaire information unit 143 stores questions and a corresponding plurality of answer choices related to the questionnaire, for each type of questionnaire. The questionnaire information unit 143 will be described later with reference to FIG. 5. The coupon information unit 144 stores information of various coupons. The coupon information is printed on a receipt to be issued to the customer. Also, the coupon information is transmitted to an email address used in a terminal device such as a portable terminal or a personal computer owned by the customer. The customer receives a coupon printed on the receipt and the coupon sent by email. In the embodiment, when the customer is a member of a store where the commodity is purchased or a member of a company that manages the store, a 2% discount coupon is issued. A 3% discount coupon is sent by email to a member who also subscribes to an email magazine. For the customer who is not a member, a 1% discount coupon is issued. The customer master 145 stores customer information for each customer code that identifies the customer as a member. The customer master 145 also stores the email address in association with the customer code. The questionnaire storing unit 146 stores the questions and the answer choices of the questionnaire to be displayed on the customer display device 18.

The control unit 100 is connected to the operator display device 17, the customer display device 18, an operation panel 19, and the symbol reading unit 20 via the data bus 15 and a controller 16. The operator display device is, for example, a liquid crystal display device. The operator display device 17 displays commodity information of the commodity from which the symbol reading unit 20 read the symbol. A touch panel 171 which receives an operation by touching is provided on the display screen of the operator display device 17. The operation of a key displayed on the operator display device 17 is received by touching the touch panel 171 at a position corresponding to the key. The customer display device 18 is, for example, a liquid crystal display device. The customer display device 18 displays commodity information of the commodity from which the symbol reading unit 20 read the symbol. The customer display device 18 displays the question from the questionnaire regarding the specific commodity and the plurality of answer choices for the question. A touch panel 181 for receiving an operation by touching is provided on the display screen of the customer display device 18. An operation of an answer choice displayed on the customer display device 18 is received by touching the touch panel 181 at a position corresponding to the answer choice.

The operation panel 19 is a keyboard for operating the commodity information reading apparatus 1. The operation panel 19 includes an end key 191. The end key 191 is operated by the operator when the sales registration process of all the commodities is ended.

The symbol reading unit 20 is an apparatus that optically reads symbols such as a bar code and a two-dimensional code attached to a commodity. The symbol reading unit 20 reads a symbol by receiving reflected light from the symbol of light emitted by the symbol reading unit 20 or reflected light from natural light. The symbol reading unit 20 may read a symbol based on an image obtained by imaging the symbol.

The control unit 100 is connected to a communication I/F 21 via the data bus 15. The communication I/F 21 transmits and receives information to and from the POS terminal 3 via the communication line L3. For example, the control unit 100 transmits commodity information and questionnaire result information to the POS terminal 3 via the communication I/F 21.

Next, the commodity master 142 will be described, as illustrated in FIG. 4. Each record of a plurality of records in the commodity master 142 includes a commodity code 1421, a commodity name 1422, a unit price 1423, a questionnaire code 1424, a number-of-sales 1425, and a sales amount 1426.

The commodity code 1421 is a commodity code for specifying a commodity. The commodity name 1422 is a commodity name of a commodity specified by a commodity code in correlation with the commodity code of the commodity. The unit price 1423 is a unit price (price of one commodity) of the commodity specified by the commodity code in correlation with the commodity code of the commodity.

The questionnaire code 1424 is information as to whether the commodity specified by the commodity code is a predetermined commodity or not. Specifically, the questionnaire code 1424 is a code indicating whether a corresponding questionnaire exists or not. In the example of FIG. 4, the commodity for which a code “000” is stored in the questionnaire code 1424 is a normal commodity which is not correlated with a questionnaire. On the other hand, a commodity (commodity B) for which a code “003” is stored in the questionnaire code 1424 is a specific commodity which is correlated with a questionnaire.

The number-of-sales 1425 is the number of sales (number of commodities subjected to sales registration process) of the commodity specified by the commodity code. The sales amount 1426 is a sales amount (unit price x sales amount) of the commodity specified by the commodity code. When the commodity code is specified based on the read symbol, commodity information corresponding to the commodity code is extracted by referencing the commodity master 142. The number-of-sales 1425 and the sales amount 1426 may be provided in a memory separate from the commodity master 142.

Next, the questionnaire information 143 will be described. The questionnaire information 143 includes a questionnaire code 1431, a designation 1432, a question matters 1433, an answer code 1434, and an answer display 1435. The questionnaire code 1431 is a code for specifying the type of the questionnaire. In the example of FIG. 5, three types of questionnaire codes, including a questionnaire code “001”, a questionnaire code “002”, and a questionnaire code “003” are illustrated.

The designation 1432 is information indicating whether a questionnaire specified by a questionnaire code is specified or not. When information “1” is stored in the designation 1432, the corresponding questionnaire is designated as a questionnaire related to a specific commodity. When information “2” is stored in the designation 1432, the corresponding questionnaire is designated as a questionnaire related to a transaction or a store. When information “0” is stored in the designation 1432, a corresponding questionnaire is not designated.

The question matters 1433 is a question of a questionnaire specified by a questionnaire code. The answer code 1434 is a code for specifying answer choices correlated one to one with a plurality of answer choices displayed as answer items of the questionnaire. The answer display 1435 is information of a plurality of answer choices to be answered to the questionnaire displayed on the customer display device 18.

In the example of FIG. 5, the questionnaire corresponding to the questionnaire code “001” is a questionnaire relating to the operator performing the transaction with the customer. A code “2” is stored in the designation 1432 corresponding to the questionnaire code “001”. This indicates that the questionnaire corresponding to the questionnaire code “001” is designated and the questionnaire corresponding to the questionnaire code “001” is a questionnaire to be displayed during the settlement process. In the question matters 1433 corresponding to the questionnaire code “001”, the question relating to the operator performing the transaction with the customer is stored. In the question matters 1433, for example, questions such as “Please give us your opinion about a response delivered by a clerk in charge of a register” are stored.

In the answer display 1435 corresponding to the questionnaire code “001”, a plurality of answer choices which are corresponding to questions relating to the operator performing the transaction with the customer and are displayed on the customer display device 18 are stored. In the case of the example of FIG. 5, five types of answer choices, “good”, “fast”, “normal”, “bad”, “nothing special” corresponding to the questions stored in the question matters 1433 is stored.

In the answer code 1434, codes which specify the answer choices and correspond to the answer choices stored in the answer display 1435. An answer code “0001” corresponds with the answer choice “good”. An answer code “0002” corresponds with the answer choice “fast”. An answer code “0003” corresponds with the answer choice “normal”. An answer code “0004” corresponds with the answer choice “bad”. An answer code “0005” corresponds with the answer choice “nothing special”.

The questionnaire corresponding to the questionnaire code “002” is a questionnaire on the reason why customers chose the store they visited. A code “0” in the designation 1432 corresponds to a questionnaire code “002”. This indicates that no questionnaire corresponds to the questionnaire code “002”. The question matters 1433 corresponding to the questionnaire code “002” is the question on the reason why the customers chose the store. The question matters 1433, is, for example, a question such as “Please tell us the reason why you chose our store.”

The answer display 1435, corresponding to the questionnaire code “002”, includes a plurality of answer choices corresponding to questions on the reason why the customers chose the store, and the answer choices are displayed on the customer display device 18. In the case of the example of FIG. 5, the answer choices of “because it is close”, “price is cheap”, “quality is fresh”, “feel at ease” and “unavoidably” are included in the question matters 1433 is stored.

The answer code 1434 includes codes which specify the answer choices and are correlated with the answer choices stored in the answer display 1435. An answer code “0001” corresponds to the answer choice “because it is close”. An answer code “0002” corresponds to the answer choice “price is cheap”. An answer code “0003” corresponds to the answer choice “quality is fresh”. An answer code “0004” corresponds to answer choice “feel at ease”. An answer code “0005” corresponds to the answer choice “unavoidably”.

The questionnaire corresponding to the questionnaire code “003” is a questionnaire related to a specific commodity. A code “1” in the designation 1432 corresponds to the questionnaire code “003”. This indicates that the questionnaire code “003” does not correspond to a questionnaire related to a specific commodity. The question matters 1433 corresponding to the questionnaire code “003” includes question matters related to the specific commodity. The question matters 1433 includes, for example, the question matters such as “Where did you know the commodity B?”

The answer display 1435 corresponding to the questionnaire code “003” includes a plurality of answer choices corresponding to the questions on places or means where the customer knew the specific commodity and are answer choices displayed on the customer display device 18. In the case of the example of FIG. 5, the answer choices of “saw it on television”, “saw it online”, “store's leaflet”, and “did not know” correspond to the question in the question matters 1433.

The answer code 1434 includes codes which specify the answer choices correlated one-to-one with the answer choice in the answer display 1435. An answer code “0001” corresponds to the answer choice “saw it on TV”. An answer code “0002” corresponds to the answer choice “saw it online”. An answer code “0003” corresponds to the answer choice “store's leaflet”. An answer code “0004” corresponds to the answer choice “did not know”.

Next, a hardware configuration of the POS terminal 3 will be described. FIG. 6 is a block diagram illustrating a hardware configuration of the POS terminal 3. As illustrated in FIG. 6, the POS terminal 3 includes a CPU 31, a ROM 32, a RAM 33, a memory unit 34, and the like. The CPU 31 controls various components. The ROM 32 stores various programs. The RAM 33 develops various pieces of data. The memory unit 34 stores various programs. The CPU 31, the ROM 32, the RAM 33, and the memory unit 34 are connected to each other via a data bus 35. The CPU 31, the ROM 32, and the RAM 33 constitute a control unit 300. That is, the control unit 300 executes a control process described later by causing the CPU 31 to operate according to a control program stored in the ROM 32 or the memory unit 34 and developed in the RAM 33.

The RAM 33 includes a commodity information unit 331. The commodity information unit 331 stores commodity information received from the commodity information reading apparatus 1. The commodity information unit 331 stores settlement information subjected to a settlement process by the POS terminal 3. The commodity information unit 331 stores an answer to the questionnaire in association with the commodity information and settlement information.

The memory unit 34 includes a control program unit 341, a commodity master 342, a questionnaire information unit 343, a coupon information unit 344, and a customer master 345. The control program unit 341 stores a program for controlling a process of the POS terminal 3.

The commodity master 342 has the same configuration as the commodity master 142. The commodity master 342 has the same configuration as the commodity master 142 illustrated in FIG. 4. That is, the commodity code 3421, the commodity name 3422, the unit price 3423, the questionnaire code 3424, the number-of-sales 3425, and the sales amount 3426 (none of the data records are illustrated) in the commodity master 342 correspond to the commodity code 1421, the commodity name 1422, the unit price 1423, the questionnaire code 1424, the number-of-sales 1425, and the sales amount 1426 in the commodity master 142, respectively.

The questionnaire information unit 343 has the same configuration as the questionnaire information unit 143. The questionnaire information unit 343 has the same configuration as the questionnaire information unit 143 illustrated in FIG. 5. That is, a questionnaire code 3431, a designation 3432, a question matters 3433, an answer code 3434, and an answer display 3435 (none of the data records are illustrated) of the questionnaire information unit 343 correspond to the questionnaire code 1431 of the questionnaire information unit 143, designation 1432, question matters 1433, answer code 1434, answer display 1435 of the questionnaire information unit 143, respectively.

The coupon information unit 344 has a configuration equivalent to that of the coupon information unit 144. The customer master 345 has the same configuration as the customer master 145.

The questionnaire information unit 143 may store questionnaire information on a specific commodity, for example such as, questionnaire information of a questionnaire code “003” and the questionnaire information unit 343 may store, for example, questionnaire information related to the transactions and stores other than questionnaires on a specific commodity, for example such as, questionnaire codes “001” and “002”.

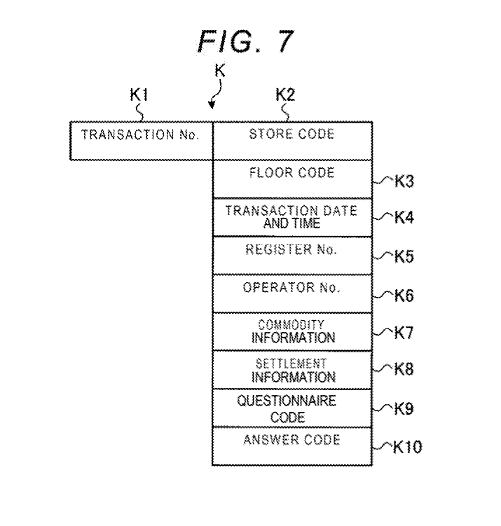

The questionnaire information unit 343 stores questionnaire information, commodity information, and information on transactions in association with each other. FIG. 7 is an example of information (answer information) stored in the questionnaire information unit 343.

In FIG. 7, answer information K stores commodity information and questionnaire information for each transaction number. Specifically, the answer information K includes a transaction No. K1, a store code K2, a floor code K3, a transaction date and time K4, a register No. K5, an operator No. K6, a commodity information K7, a settlement information K8, a questionnaire code K9, and an answer code K10.

The transaction No. K1 is a transaction number (transaction specifying information) specifying the transaction. The transaction number is generated by the POS terminal 3 when the transaction with the customer is performed. The store code K2 is a store code for specifying the store where the transaction was made. The store code is stored in the POS terminal 3. The floor code K3 is a floor code for specifying thee floor of the store where the transaction was performed. The floor code is stored in the POS terminal 3 that processed the transaction. The transaction date and time K4 is date and time information indicating when the transaction was performed. The POS terminal 3 obtains date and time information based on information transmitted by a timer (not illustrated). The register No. K5 is a register number (apparatus specifying information) for specifying the POS terminal 3 on which the transaction was made. Each POS terminal 3 stores the register number for specifying the POS terminal 3. The operator No. K6 is an operator number for specifying an operator in charge of the transaction. When signing in the POS terminal 3, the operator inputs an operator number for specifying the operator in charge of the POS terminal 3. For that reason, the signed-in POS terminal 3 stores the operator number of the operator in charge. The commodity information K7 is commodity information of the commodity subjected to the sales registration process in the transaction. The settlement information K8 is settlement information for the commodity subjected to the settlement process in the transaction. The questionnaire code K9 is a questionnaire code for specifying the questionnaire displayed on the customer display device 18 and the customer display device 38 in the transaction. In the embodiment, the questionnaire code of the questionnaire displayed on the customer display device 18 and the customer display device 38 among the questionnaires of the questionnaire codes “001”, “002”, and “003” is stored. The answer code K10 is an answer code (the answer code 1434 in FIG. 5) for specifying an answer choice by allowing a customer to operate a questionnaire displayed on the customer display device 18 and the customer display device 38. The answer code K10 is stored in association with the questionnaire code of the questionnaire. By storing as such, it is possible to know what answer is obtained for which questionnaire, based on the questionnaire code K9 and the answer code K10 associated with the questionnaire code K9.

When the transaction number is specified based on the questionnaire information unit 343 storing such information, it is possible to specify the store, the operator who was in charge of the POS terminal 3, commodity information and settlement information of the purchased commodity, the questionnaire displayed during the transaction, and the answer information corresponding to the transaction number. It is possible to specify the operator who is in charge of the POS terminal 3 corresponding to answer information, the date and time and the time zone when the answer is made. Also, it is possible to associate a specific commodity with answer information.

The control unit 300 is connected to the operator display device 37, the customer display device 38, the operation panel 39, and a printing unit 40 via the data bus 35 and a controller 36. The operator display device 37 has the configuration equivalent to that of the operator display device 17. The customer display device 38 has the configuration equivalent to that of the customer display device 18. The operation panel 39 has the configuration equivalent to that of the operation panel 19, but includes a settlement key 391 instead of the end key 191. The settlement key 391 is operated to end the transaction. The printing unit 40 is, for example, a thermal printer, and issues a receipt on which commodity information and settlement information are printed. The printing unit 40 prints a coupon and issues the coupon.

A touch panel 371 is provided on a display screen of the operator display device 37. A touch panel 381 is provided on a display screen of the customer display device 38. The touch panel 371 has the configuration equivalent to that of the touch panel 171. The touch panel 381 has the configuration equivalent to that of the touch panel 181.

The control unit 300 is connected to a communication I/F 41 via the data bus 35. The communication I/F 41 transmits and receives information to and from the commodity information reading apparatus 1 via the communication line L3. For example, the control unit 300 receives commodity information, questionnaire result information, and the like from the commodity information reading apparatus 1 via the communication I/F 41. The communication I/F 41 transmits and receives information to and from the store server 5 via the communication line L1. For example, the control unit 300 transmits commodity information, settlement information, questionnaire result information, customer's email information, and the like to the store server 5 via the communication I/F 41.

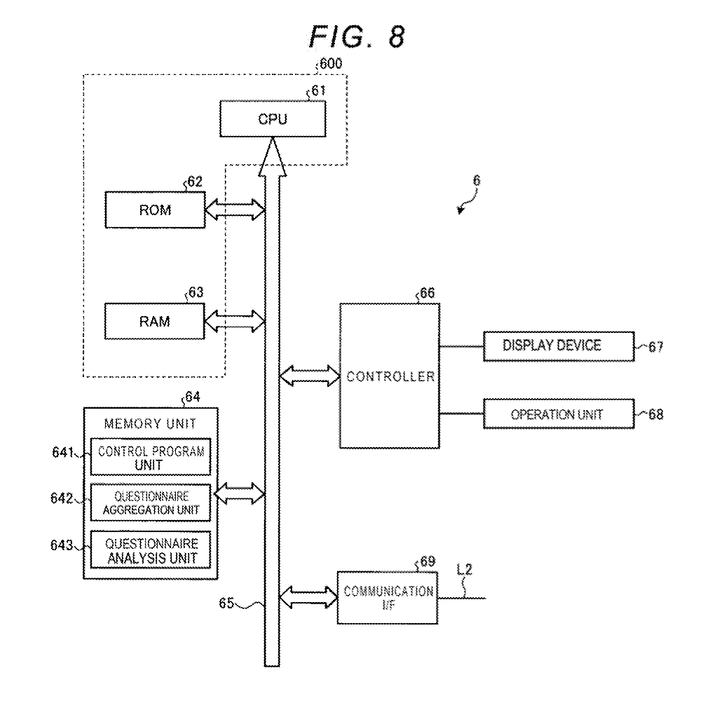

Next, a hardware configuration of the head office server 6 will be described. FIG. 8 is a block diagram illustrating a hardware configuration of the head office server 6. As illustrated in FIG. 8, the head office server 6 includes a CPU 61, a ROM 62, a RAM 63, a memory unit 64, and the like. The CPU 61 controls various components. The ROM 62 stores various programs. The RAM 63 develops various pieces of data. The memory unit 64 stores various programs. The CPU 61, the ROM 62, the RAM 63, and the memory unit 64 are connected to each other via a data bus 65. The CPU 61, the ROM 62, and the RAM 63 function as a control unit 600. That is, the control unit 600 executes a control process to be described later by allowing the CPU 61 to operate according to a control program stored in the ROM 62 and the memory unit 64 and developed in the RAM 63.

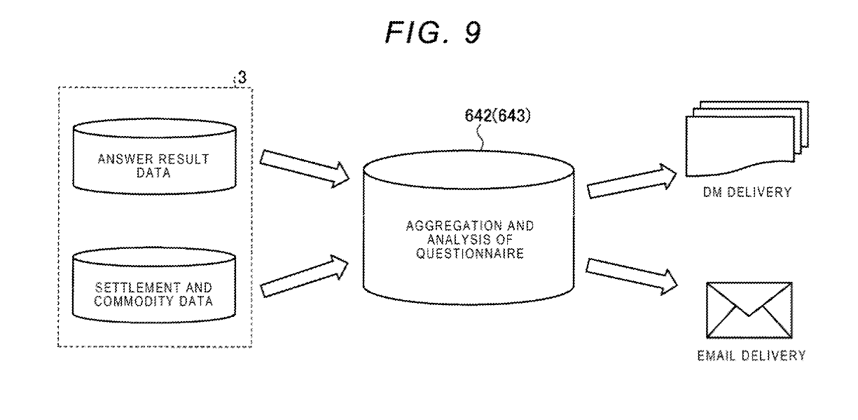

The memory unit 64 includes a control program unit 641, a questionnaire aggregation unit 642, and a questionnaire analysis unit 643. The control program unit 641 stores a program for controlling processing of the head office server 6. The questionnaire aggregation unit 642 collects and stores information, which is stored in the questionnaire information unit 343 including questionnaire answers that were made by each of the commodity information reading apparatus 1 and the POS terminal 3, via the store server 5. The questionnaire aggregation unit 642 collects similar information from the store T2 and the store T3, in addition to the store T1. The questionnaire analysis unit 643 stores the results obtained by performing analysis based on the questionnaire on the basis of information collected by the questionnaire aggregation unit 642. Analysis based on the questionnaire will be described with reference to FIG. 9.

The control unit 600 is connected to the display device and the operation unit 68 via the data bus 65 and the controller 66. The display device 67 displays information. The operation unit 68 is a keyboard for inputting information. The control unit 600 is connected to a communication I/F 69 via the data bus 65. The communication I/F 69 performs transmission and reception of information such as collection of the information described above with the store server 5 via the communication line L2.

Next, an analysis based on a questionnaire performed by the control unit 600 of the head office server 6 will be described with reference to FIG. 9. The head office server 6 receives commodity information and settlement information from the POS terminal 3 via the store server 5. The head office server 6 receives answer information stored in the questionnaire information unit 343 from the POS terminal 3 via the store server 5. The received answer information is collected in the questionnaire aggregation unit 642. Among the collected information, in particular, the answer information received from the questionnaire information unit 343 is aggregated and analyzed.

For example, the impression of the customer to each operator is analyzed based on the collected answer information of the questionnaire code “001” and the operator number. Analysis results are used for training of operators. The impression on the store is analyzed based on the collected answer information of the questionnaire code “002” and the store code. Analysis results are used for improving store operations. Also, the motivation that the customer purchased the commodity is analyzed based on the aggregated answer information of the questionnaire code “003” and the corresponding commodity. Analysis results are used for increasing purchasing of the commodity.

Direction of collaborative activities between stores and manufacturers for the commodities is analyzed based on the aggregated answer information of the questionnaire code “003” and the corresponding commodity. Directed materials relating to PR activities of stores to customers and specific commodities are sent based on the analysis result of the questionnaire code “002” and the questionnaire code “003.” Directed materials may be sent by being attached to emails.

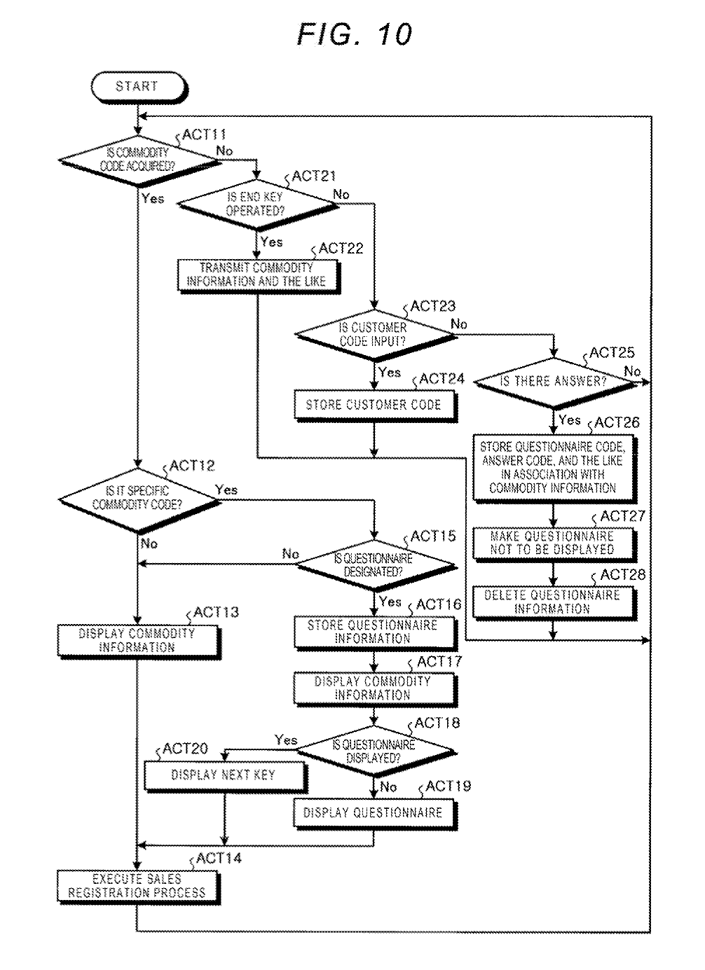

The control process of the commodity information reading apparatus 1 according to the embodiment will be described from here. The operator performs sales registration operation of holding the symbol attached to the commodity purchased by the customer to the symbol reading unit 20, in the commodity information reading apparatus 1. FIG. 10 is a flowchart illustrating a flow of a control process of the commodity information reading apparatus 1. As illustrated in FIG. 10, based on the symbols read by the symbol reading unit 20, the control unit 100 of the commodity information reading apparatus 1 determines whether a commodity code specifying the commodity is acquired or not (Act11). When it is determined that the commodity code is acquired (Yes in Act11), the control unit 100 determines whether the commodity specified by the commodity code is a predetermined commodity or not (Act12). The control unit 100 determines, based on information stored in the questionnaire code unit 1424 of the commodity master 142, whether the commodity is the predetermined commodity or not. When it is determined that information indicating that there is a questionnaire correlated with the commodity is stored in the questionnaire code unit 1424, the control unit 100 determines that it is a predetermined commodity. In the case of the embodiment, when the questionnaire code “003” is stored in the questionnaire code unit 1424, the control unit 100 determines that the commodity is a specific commodity. When the questionnaire code “003” is not stored in the questionnaire code unit 1424, the control unit 100 does not determine that the commodity is a specific commodity.

When it is determined that the commodity is not a predetermined commodity (No in Act12), the control unit 100 reads commodity information of the commodity from the commodity master 142 corresponding to the commodity code, and displays the commodity information on the operator display device 17 and the customer display device 18 (Act13). Then, the control unit 100 executes the sales registration process for the commodity of the displayed commodity information (Act14). Then, the control unit 100 returns to Act11.

On the other hand, in Act12, when it is determined that the commodity specified by the commodity code is a predetermined commodity (Yes in Act12), the control unit 100 determines whether a questionnaire to be displayed for the commodity is designated or not (Act15). The control unit 100 determines, based on the designation 1432 of the questionnaire information unit 143, whether the questionnaire to be displayed for the commodity is designated or not. When “1” is stored in the designation 1432, it is determined that the questionnaire to be displayed for the commodity is designated. When information other than “1” is stored in the designation 1432, it is determined that the questionnaire to be displayed for the commodity is not designated. In the embodiment, “1” is stored in the designation 1432 with respect to the questionnaire of the questionnaire code “003”.

When it is determined that the questionnaire to be displayed for the commodity is designated (Yes in Act15), the control unit 100 stores the question of the questionnaire for the commodity, answer choices and the like to be displayed on the customer display device 18 in the questionnaire storing unit 146 (Act16). Next, the control unit 100 displays commodity information of the commodity on the operator display device 17 and the customer display device 18 (Act17). Next, the control unit 100 determines whether another questionnaire is already displayed on the customer display device 18 or not (Act18). When it is determined that the other questionnaire is not displayed (No in Act18), the control unit 100 displays the questionnaire related to the commodity on the customer display device 18 (Act19). On the other hand, when it is determined that another questionnaire is already displayed on the customer display device 18 (Yes in Act18), the control unit 100 further displays a questionnaire display key 184 indicating the presence of another questionnaire to be answered in a corner of the customer display device 18 on which the questionnaire is displayed. The customer operates the questionnaire display key 184 such that another questionnaire is displayed on the customer display device 18. The customer can see the content of the other questionnaire. When there is no other questionnaire to answer, the questionnaire display key 184 is not displayed. In Act15, when it is determined that the questionnaire is not designated (No in Act15), the control unit 100 executes the process in Act13 and subsequent steps. After the process of Act19 and the process of Act20, the control unit 100 executes the process of Act14. At this stage, the control unit 100 does not store the commodity information, the questionnaire code, and the answer code in association with each other.

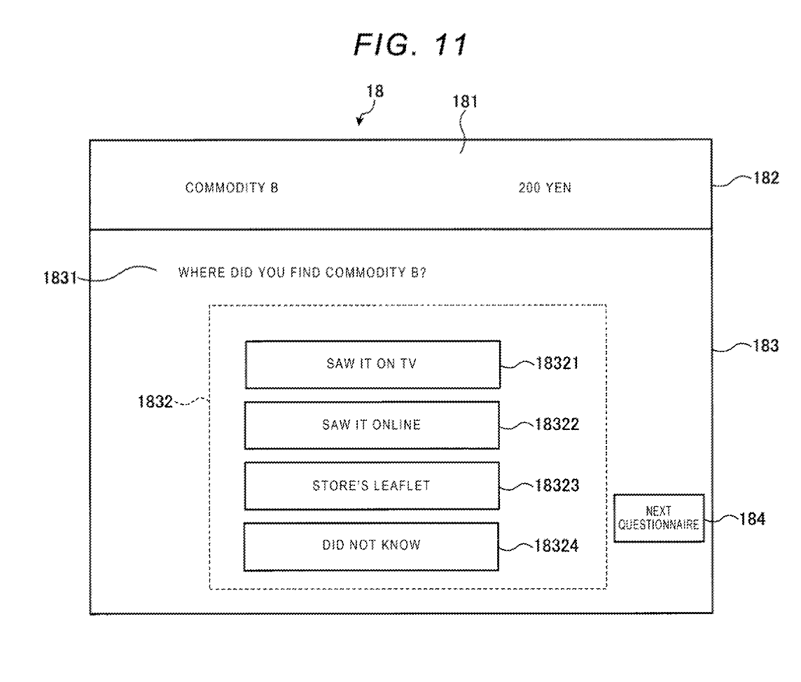

FIG. 11 illustrates a display example of the customer display device 18. The customer display device 18 includes a commodity information display area 182 and a questionnaire display area 183. The touch panel 181 covering the entire display screen is provided on the display screen of the customer display device 18. On the commodity information display area 182, commodity information is displayed based on the process of Act16. On the questionnaire display area 183, a questionnaire is displayed based on the process of Act17.

The questionnaire display area 183 has a question area 1831 for displaying the question matters of the questionnaire and an answer choice area 1832 for displaying a plurality of answer choices of commodities to be answers to the questionnaire. In the question area 1831, question matters stored in the question matters 1433 are displayed. In the answer choice area 1832, a plurality of answer choices stored in the answer display 1435 are displayed. The questionnaire display area 183 displays the questionnaire display key 184 when there is another questionnaire to be answered.

In the embodiment, question matters of the questionnaire related to the questionnaire code “003” are read from the question matters 1433 and displayed in the question area 1831. A plurality of answer choices corresponding to the question matters of the questionnaire code “003” are read from the answer display 1435 and displayed on the answer choice unit 1832. As the plurality of answer choices, an answer choice 18321 of “saw it on TV”, an answer choice 18322 of “saw it online”, an answer choice 18323 of “store's leaflet”, and an answer choice 18324 of “did not know” are displayed.

When the customer answers the questionnaire, the customer sees the displayed questionnaire, selects one answer choice from the plurality of displayed answer choices, and operates the touch panel 181 at the position corresponding to the corresponding answer choice. When the customer does not answer the questionnaire, the customer may not operate any answer choice.

On the other hand, in Act11, when it is determined that the commodity code is not acquired (No in Act11), the control unit 100 determines whether the end key 191 of the operation panel 19 is operated or not (Act21). When it is determined that the end key 191 is operated (Yes in Act21), the control unit 100 transmits commodity information stored in the commodity information unit 131 to the POS terminal 3 (Act22). When the customer answers the questionnaire displayed on the customer display device 18, in the process of Act22, the questionnaire code of the questionnaire displayed on the customer display device 18 related to the commodity and the answer code corresponding to the answer choice operated by the customer are transmitted in association with commodity information of the commodity. Then, the control unit 100 returns to Act11.

When it is determined that the end key 191 is not operated (No in Act21), the control unit 100 determines whether a customer code specifying the customer is input from a customer card read by a card reading device (not illustrated) or not (Act23). When it is determined that the customer code is input (Yes in Act23), the customer code is stored in the commodity information unit 131 (Act24). Then, the control unit 100 returns to Act11. In Act24, when the customer code is stored in the commodity information unit 131, the stored customer code is transmitted to the POS terminal 3 in Act22.

On the other hand, when it is determined that the customer code is not input (No in Act23), the control unit 100 determines whether or not there is an answer to the questionnaire as a result of any answer choice being operated (Act25). In the process of Act25, the questionnaire code (“003” in the embodiment) stored in the questionnaire code 1431 is stored as the questionnaire code. The answer code stored in the answer code 1434 corresponding to the operated answer choice is stored as an answer code. Also, the questionnaire code and the answer code are stored in correspondence with each other.

When it is determined that there is an answer (Yes in Act25), the control unit 100 associates a questionnaire code for specifying a questionnaire related to the commodity, an answer code corresponding to the selected answer choice, and an answer date and time with the commodity information of the commodity subjected to the sales registration process in Act14 and stores the questionnaire code, the answer code, and the answer date and time in the commodity information unit 131 (Act26). Then, the control unit 100 makes the questionnaire of the commodity of which information is stored in Act26 not to be displayed on the customer display device (Act27). Then, the control unit 100 deletes information on the questionnaire from the questionnaire storing unit 146. When information of other questionnaires is stored in the questionnaire storing unit 146, the questionnaire is not displayed in Act27 and other questionnaires are displayed. Then, the control unit 100 returns to Act11. When it is determined that there is no answer to the questionnaire (No in Act25) in Act25, the control unit 100 returns to Act11.

When the operator repeats the operation of sales registration for all the commodities purchased by the customer, the commodity information reading apparatus 1 executes the sales registration process for all the commodities for which the sales registration operation is performed. When the customer answers the questionnaire displayed on the customer display device 18, the customer selects any of the answer choices.

In such a commodity information reading apparatus 1, when there is a questionnaire corresponding to a commodity, questions of the questionnaire and answer choices are displayed on the customer display device 18 when purchasing the commodity. The customer can easily answer the questionnaire by operating any of the answer choices of the displayed answer items. For that reason, the commodity information reading apparatus 1 can obtain an answer to a questionnaire in real time. The customer who answers can correctly answer the questionnaire without forgetting the impression experienced in the store. A store can obtain an accurate answer.

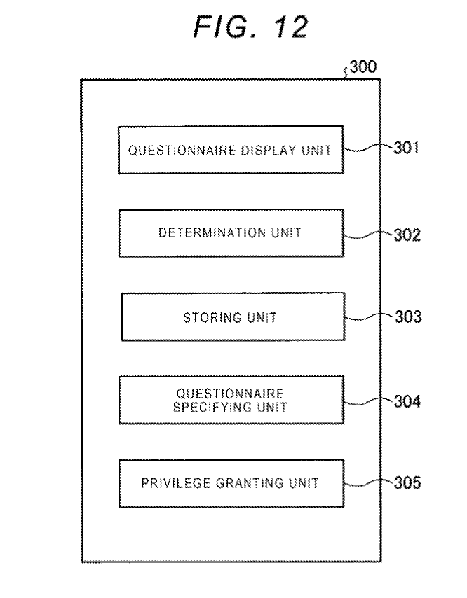

Next, a control process of the POS terminal 3 according to the embodiment will be described. FIG. 12 is a functional block diagram illustrating a functional configuration of the POS terminal 3. The control unit 300 functions as a questionnaire display unit 301, a determination unit 302, a storing unit 303, a questionnaire specifying unit 304, and a privilege granting unit 305 by executing the control program stored in the ROM 32 or the memory unit 34 and developed in the RAM 33.

The questionnaire display unit 301 has a function of displaying a questionnaire related to a transaction on the customer display device 38 during the transaction with the customer.

The determination unit 302 has a function of determining whether there is an answer to the questionnaire displayed on the customer display device 38 or not.

The storing unit 303 has a function of storing the answer of the questionnaire determined by the determination unit 302 that there is an answer reply.

The questionnaire specifying unit 304 has a function of specifying a questionnaire intended to obtain an answer from a plurality of questionnaires stored in the questionnaire information unit 343.

The privilege granting unit 305 has a function of granting a privilege to the customer who answers when the determination unit 302 determines that there is an answer to the questionnaire displayed on the customer display device 38.

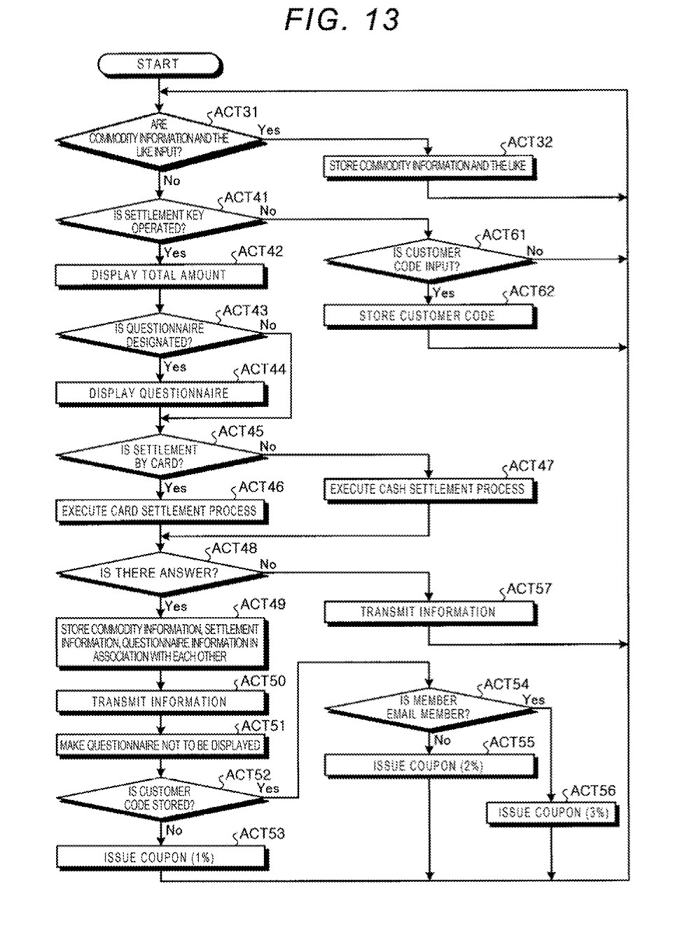

FIG. 13 is a flowchart illustrating a flow of a control process of the POS terminal 3. As illustrated in FIG. 13, the control unit 300 determines whether commodity information and the like are input from the commodity information reading apparatus 1 or not (Act31). When it is determined that the commodity information or the like is input (Yes in Act31), the control unit 300 stores the commodity information and the like in the commodity information unit 331 (Act32). Then, the control unit 30 returns to Act31. When questionnaire information (questionnaire code or answer code) transmitted by the commodity information reading apparatus 1 and the customer code are included in the commodity information and the like in addition to the commodity information, these pieces of information are also stored in the process of Act32.

When it is determined that commodity information or the like is not input from the commodity information reading apparatus 1 (No in Act31), the control unit 300 determines whether the settlement key 391 provided in the operation panel 39 is operated or not (Act41). When it is determined that the settlement key 391 is operated (Yes in Act41), the control unit 300 calculates the total amount of the transaction based on the commodity information stored in the commodity information unit 331 in Act32 and displays the total amount of the transaction on the operator display device 37 and the customer display device 38 (Act42). Next, the control unit 300 (questionnaire specifying unit 304) determines whether a questionnaire related to the transaction is designated or not (Act43).

The control unit 300 determines, based on information in the designation 3432 of the questionnaire information unit 343, whether the questionnaire related to a transaction or a store is designated or not. In the case of the embodiment, when “2” is the designation 3432, the control unit 300 determines that the questionnaire related to the transaction or the store is designated in Act43. When information other than “2” is the designation 3432, the control unit 300 determines that the questionnaire related to the transaction or the store is not designated in Act43. In the embodiment, since the information “2” is the designation 3432 corresponding to the questionnaire code “001”, it is determined that the questionnaire code “001” is designated.

When it is determined that the questionnaire is designated (Yes in Act43), the control unit 300 (questionnaire display unit 301) displays the designated questionnaire on the customer display device 38 (Act44).

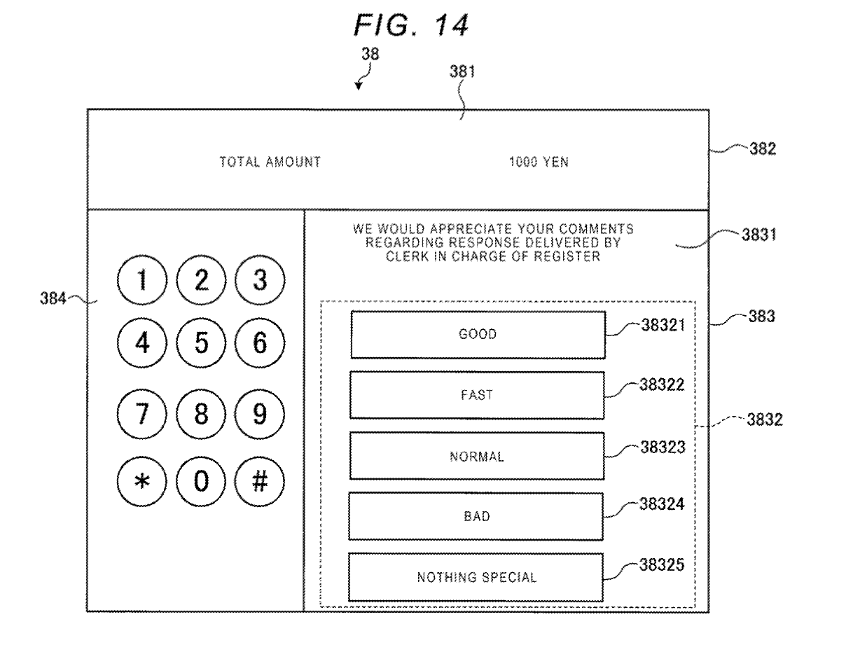

FIG. 14 illustrates a display example in which total amount information displayed in Act42 and the questionnaire in Act44 are displayed on the customer display device 38. In FIG. 14, the customer display device 38 includes a total amount area 382 for displaying the total amount, a questionnaire display area 383 for displaying questionnaire information, a password information area 384 for displaying information for inputting a password number. The touch panel 381 covering the entire display screen is provided on the display screen of the customer display device 38. The total amount area 382 displays the total amount of the commodity purchased in the transaction processed in Act42. The amount of deposit deposited from the customer, the change amount, and the like are also displayed in the total amount area 382.

The questionnaire display area 383 has a question area 3831 for displaying question matters of the questionnaire and an answer choice area 3832 for displaying a plurality of answer choices of commodities to be answers to the questionnaire. In the question area 3831, question matters 3433 are displayed. In the answer choice area 3832, the answer choices in the answer display 3435 are displayed.

In the embodiment, questions of the questionnaire related to the questionnaire code “001” are read from the question matters 3433 and displayed in the question area 3831. A plurality of answer choices corresponding to the questions corresponding to questionnaire code “001” are read from the answer display 3435 and displayed on the answer choice area 3832. As the answer choices of the questionnaire related to the operator corresponding to the transaction with the customer, an answer choice 38321 of “good”, an answer choice 38322 of “fast”, an answer choice 38323 of “normal”, an answer choice 38324 of “bad”, and an answer choice 38325 of “nothing special” are displayed.

The customer sees the displayed questionnaire, selects one answer choice from the plurality of displayed answer choices, and operates the touch panel 381 at the position corresponding to the corresponding answer choice. The customer may not operate any answer choice.

The password information area 384 displays numerals 0 to 9 and symbols “*” and “#.” When a settlement is made with a card such as a membership card to which a credit function is added, the customer operates a password number and a symbol to input a password number.

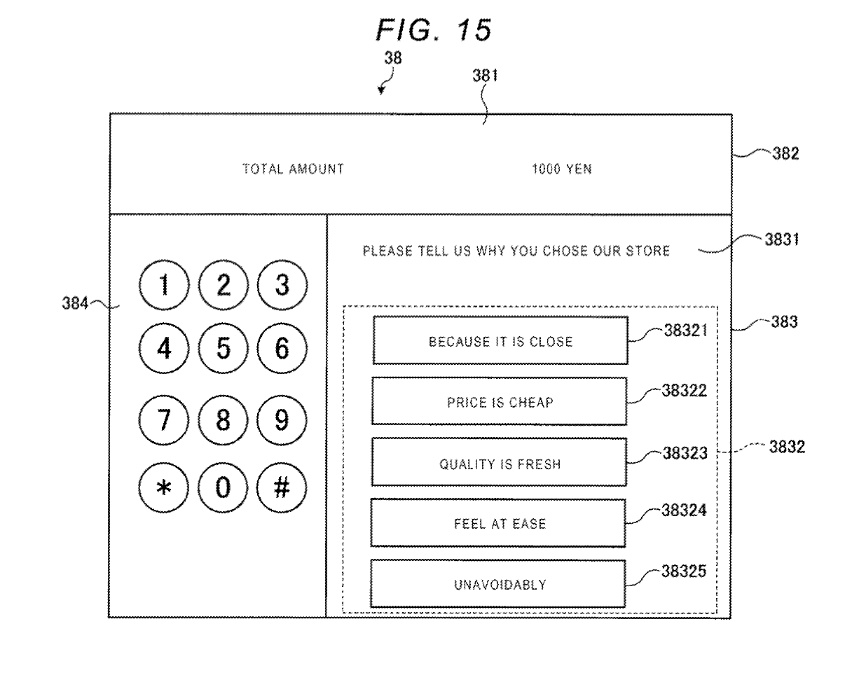

In Act43, when it is determined that a questionnaire of the questionnaire code “002” is designated (in this case, information “2” in the designation 3432 corresponding to the questionnaire code “002”), the questionnaire as illustrated in FIG. 15 is displayed. That is, in the question area 3831, a question about the reason why the customer chose the store he/she visited is displayed. In the answer choice area 3832, an answer choice about the reason why the customer chose the store he/she visited is displayed. Specifically, as answer choices of the questionnaire, an answer choice 38321 of “because it is close”, an answer choice 38322 of “price is cheap”, an answer choice 38323 of “quality is fresh”, an answer choice 38324 of “feel at ease”, and an answer choice 38325 of “unavoidably” are displayed. The other areas in FIG. 15 are the same as those in FIG. 14 and the description thereof is omitted. When it is determined that the questionnaire is not designated (No in Act43), the control unit 300 executes the process of Act45 without displaying a questionnaire (without performing the process of Act44).

Next, the control unit 300 determines whether the transaction is settlement by a card or not (Act45). When card information is read from a card reading unit and a settlement key (not illustrated) for designating settlement by the card is operated, the control unit 300 determines that the transaction is settlement by the card. When a settlement key (not illustrated) indicating settlement with cash is operated, the control unit 300 determines that the transaction is not settlement by the card.

When it is determined that it is card settlement (Yes in Act45), the control unit 300 executes a settlement process with the card (Act46). That is, the control unit 300 determines whether the password input from the password information area 384 is correct or not, and when the password is correct, the control unit 300 executes the settlement process by the card. When it is determined that it is not the card settlement (No in Act45), the control unit 300 executes the settlement process by cash (Act47).

Next, the control unit 300 (determination unit 302) determines whether the customer answered to the questionnaire displayed on the customer display device 38 or not (Act48). When any of the answer choices is operated on display of the questionnaire in Act44, the control unit 300 determines that there is an answer from the customer. When questionnaire information (questionnaire code or answer code) is included in information which is input from the commodity information reading apparatus 1 and stored in Act32, the control unit 300 determines that there is an answer from the customer.

When it is determined that there is an answer (Yes in Act48), the control unit 300 (storing unit 303) correlates information (questionnaire code, reply code) of a questionnaire to which the answer was made and the like with the commodity information and settlement information in the commodity information unit 331 and stores the information (questionnaire code, reply code) of the questionnaire and the like in the commodity information unit 331 (Act49). Information stored in the commodity information unit 331 in correlation with the answer is answer information K having the configuration illustrated in FIG. 7. Then, the control unit 300 transmits the stored answer information K to the store server 5 (Act50). The store server 5 transmits the received answer information K to the head office server 6. Then, the control unit 300 makes the questionnaire displayed on the customer display device 38 not to be displayed (Act51).

Next, the control unit 300 determines whether a customer code is stored in the commodity information unit 331 or not (Act52). When it is determined that the customer code is not stored (No in Act52), the control unit 300 reads discount coupon information of a discount rate of 1% from the coupon information unit 344. Then, the control unit 300 (privilege granting unit 305) prints the read coupon simultaneously with a receipt on which the commodity information and the settlement information are printed from the printing unit 40, and issues a paper medium coupon (Act53). Then, the control unit 300 returns to Act31.

When it is determined that the customer code is stored (Yes in Act52), the control unit 300 determines whether the member is an email member or not (Act54). Whether or not the member is an email member is determined based on customer information which is stored in the customer master 345 in correspondence with the customer code stored in the commodity information unit 331. When it is determined that the member is not the email member (No in Act54), the control unit 300 reads discount coupon information of a discount rate of 2% from the coupon information unit 344. Then, the control unit 300 (privilege granting unit 305) prints the read coupon simultaneously with the receipt on which the commodity information and the settlement information are printed from the printing unit 40, and issues a paper medium coupon (Act55). Then, the control unit 300 returns to Act31. When it is determined that the member is the email member (Yes in Act54), the control unit 300 reads discount coupon information of a discount rate of 3% from the coupon information unit 344. Then, the control unit 300 (privilege granting unit 305) transmits the read coupon to the email address of the member (Act56). The member's email address is acquired from customer information stored in the customer master 345 in correspondence with the customer code. Then, the control unit 300 returns to Act31. The coupon information transmitted from the POS terminal 3 is transmitted to the corresponding email address via the store server 5 or the head office server 6. As such, by increasing a value of a coupon to be issued or transmitted when the customer is a member or an email member, the customer can be motivated to join as a member or an email member.

On the other hand, in Act48, when it is determined that there is no answer to the questionnaire (No in Act48), the control unit 300 transmits the commodity information and settlement information stored in the commodity information unit 331 to the store server 5 (Act57). The store server 5 transmits the received information to the head office server 6. When there is no answer to the questionnaire, no coupon is issued or transmitted to the customer. In order to increase an answer rate to a questionnaire, when the questionnaire is displayed on the customer display device 38, a message indicating that a coupon is provided if an answer to the questionnaire is made may be displayed.

In Act41, when it is determined that it is not the operation of the settlement key 391 (No in Act41), the control unit 300 determines whether a customer code is input from a card reader (not illustrated) provided in the POS terminal 3 or connected thereto or not (Act61). When it is determined that the customer code is input (Yes in Act61), the control unit 300 stores the input customer code in the commodity information unit 331 (Act62). Then, the control unit 300 returns to Act31. When it is determined that the customer code is not input (No in Act61), the control unit 300 returns to Act31. The customer code stored in Act62 is handled in the same manner as the customer code stored in Act32.

When there is a questionnaire related to a transaction, the POS terminal 3 displays questions from the questionnaire and a plurality of answer choices on the customer display device 38 when the commodity is purchased. The customer can easily answer the questionnaire by operating any of the answer choices of the displayed answer items. For that reason, the POS terminal 3 can obtain an answer to the questionnaire in real time. The customer who answers can correctly answer a questionnaire without forgetting the impression from the store. The store can obtain an accurate answer. Particularly, in stores, there are times when purchase motivation to appeal to customer's intuition, such as urging purchase of related commodities may be made by devising a display of meal menus and thus, acquiring an answer of a real time questionnaire also leads to obtaining correct determination materials when planning appropriate commodity recommendations for individual customers or promotion events at stores.

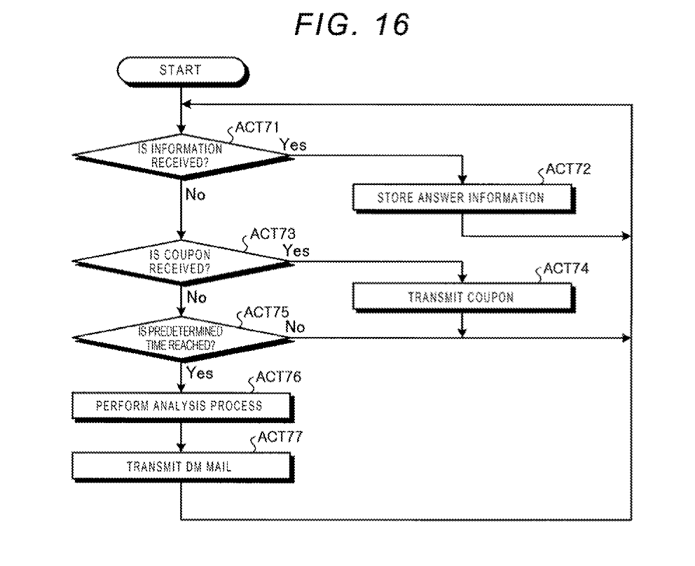

Next, a control process of the head office server 6 that collects questionnaire answers from the POS terminal 3 will be described. FIG. 16 is a flowchart illustrating a flow of a control process of a head office server. The control unit 600 of the head office server 6 determines whether answer information K is received from the POS terminal 3 via the store server 5 or not (Act71). When it is determined that answer information K is received (Yes in Act71), the control unit 600 stores the received answer information K in the questionnaire aggregation unit 642 (Act72). Then, the control unit 600 returns to Act71.

When it is determined that answer information K is not received from the POS terminal 3 (No in Act71), the control unit 600 determines whether email including coupon information is received from the POS terminal 3 via the store server 5 or not (Act73). When it is determined that email including information of the coupon is received (Yes in Act73), the control unit 600 transmits the email to a destination indicated by the email address (Act74). That is, the coupon is transmitted to the customer. Then, the control unit 600 returns to Act71.

When it is determined that the email including coupon information is not received (No in Act73), the control unit 600 determines whether the predetermined time is reached or not (Act75). When it is determined that the predetermined time has come (Yes in Act75), an analysis process for the questionnaire is performed based on answer information K stored in the questionnaire aggregation unit 642 (Act76). Then, the control unit 600 stores the result of the analysis process in the questionnaire analysis unit 643. Then, the control unit 600 transmits or sends a directed material to the customer, based on the analysis result stored in the questionnaire analysis unit 643 (Act77). The directed material may be sent by email or may be sent by being attached to the email using the Internet. The customer's email address is read out from a customer master (not illustrated). Then, the control unit 600 returns to Act71. The directed material to be transmitted or sent to the customer includes contents specific to each customer based on the analysis result. In Act75, when it is determined that the predetermined time is not reached (No in Act75), the control unit 600 returns to Act71.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the embodiment, the commodity master, questionnaire information, coupon information, and the customer master are provided in both the commodity information reading apparatus 1 and the POS terminal 3, but the exemplary embodiment is not limited thereto. These pieces of information may be provided in one of the commodity information reading apparatus 1 and the POS terminal 3 and otherwise, may be distributed in each of the commodity information reading apparatus 1 and the POS terminal 3. Also, these pieces of information may be provided in the store server 5 or the head office server 6.

In the embodiment, the coupon is transmitted to the customer via the head office server 6, but the POS terminal 3 or the store server 5 may transmit the coupon to the customer.

In the embodiment, the coupon is issued or transmitted as an example of granting a privilege, but the exemplary embodiment is not limited thereto and giving points, cash discount on the spot, provision of goods, and the like may be provided as grant of a privilege.

The store server 5 may have the configuration and functions of the head office server 6 described in the embodiment, and the store server 5 may serve also as the head office server 6.

In the embodiment, the POS terminal 3 is described as an example of an information processing apparatus, but the exemplary embodiment is not limited thereto, and for example, the commodity information reading apparatus 1 may be used as the information processing apparatus.

The program executed by the information processing apparatus according to the embodiment may be provided in a file having an installable format or an executable format so as to be recorded in a computer readable recording medium such as a CD-ROM, a flexible disk (FD), a CD-R, a digital versatile disk (DVD) may be adopted.

A configuration in which the program to be executed by the information processing apparatus of the embodiment is stored on a computer connected to a network such as the Internet and is provided by being downloaded via the network may be adopted. A configuration in which the program to be executed by the information processing apparatus of the embodiment is provided or distributed via the network such as the Internet may be adopted.

Also, the program to be executed by the information processing apparatus according to the embodiment may be provided by being incorporated in a ROM or the like in advance.

What is claimed is:

1. A point-of-sale (POS) device for use in a POS system that includes the POS device, a commodity registration device, and a store server, the POS device comprising:
a customer display device positioned to display information to a customer;
an operation panel;
a communication interface;
a memory unit; and
a processor programmed to:
control the communication interface to receive, from the commodity registration device, commodity registration information corresponding to commodities registered for purchase in a transaction,
determine whether the commodity registration information includes questionnaire information indicating one or more questions relating to the transaction to ask the customer,
if the commodity registration information includes the questionnaire information, control the customer display device to display the one or more questions indicated by the questionnaire information and a plurality of answer choices for each question,
receive a selection of one of the answer choices to each question via the operation panel,
perform a settlement processing of the transaction based on the commodity registration information and generate corresponding settlement information,
control the memory unit to store answer information including: the settlement information, the received answers choices, if any, and the commodity registration information in correspondence with each other, and
control the communication interface to transmit, to the store server, the answer information.

2. The device according to claim 1, wherein the answer information further includes, in correspondence:
transaction information that identifies the transaction,
register information that identifies the commodity registration device,
operator information that identifies an operator of the commodity registration device during the transaction, and
time information which indicates when the transaction is established.

3. The device according to claim 1, wherein
the memory unit stores a plurality of types of questionnaires, and the processor is further programmed to, based on the questionnaire information, if included in the commodity registration information, determine a specific questionnaire out of the plurality of types of questionnaires, and
the one or more questions and answer choices displayed on the display device correspond to the specific questionnaire.

4. The device according to claim 3, wherein, if the commodity registration information includes information corresponding to a predetermined commodity, the processor determines the specific questionnaire to be a first questionnaire with at least one question relating to the predetermined commodity.

5. The device according to claim 1, wherein the displayed one or more questions includes a question regarding a shopping experience of the customer.

6. The device according to claim 1, wherein the one or more questions are displayed and the selection of one of the answer choices to each question is received during the transaction.

7. The device according to claim 1, wherein the processor is further programmed to:
determine whether the selection of one of the answer choices to each question is received, and
if the selection of one of the answer choices is received, determine a reward to provide the customer.

8. The device according to claim 7, wherein the processor is further programmed to determine the reward based on whether the customer is a registered member.

9. The device according to claim 7, further comprising:
a printing unit, wherein the processor is further programmed to control the print unit to print the reward.

10. The device according to claim 7, wherein the processor is further programmed to:
receive, via the operation panel, customer information for identifying the customer, and
transmit the reward to an email address stored in correspondence with the received customer identification.

11. A method for receiving real-time questionnaire information in a point-of-sale (POS) system that includes a POS device, a commodity registration device, and a store server, the method comprising:
receiving, from the commodity registration device, commodity registration information corresponding to commodities registered for purchase in a transaction for a customer;
determining whether the commodity registration information includes questionnaire information indicating one or more questions relating to the transaction to ask the customer;
if the commodity registration information includes the questionnaire information, displaying, on a display device facing the customer, the one or more questions indicated by the questionnaire information and a plurality of answer choices for each question;
receiving a selection of one of the answer choices to each question via an operation panel;
performing a settlement processing of the transaction based on the commodity registration information and generating corresponding settlement information;
storing answer information including: the settlement information, the received answers choices, if any, and the commodity registration information in correspondence with each other; and
transmitting, to the store server, the answer information.

12. The method according to claim 11, wherein the stored answer information further includes, in correspondence:
transaction information that identifies the transaction,
register information that identifies the commodity registration device,
operator information that identifies an operator of the commodity registration device during the transaction, and
time information which indicates when the transaction is established.

13. The method according to claim 11, further comprising:
storing, in advance, a plurality of types of questionnaires; and
based on the questionnaire information, if included in the commodity registration information, determining a specific questionnaire out of the plurality of types of questionnaires, wherein
the one or more questions and answer choices displayed on the display device correspond to the specific questionnaire.

14. The method according to claim 13, wherein, if the commodity registration information includes information corresponding to a predetermined commodity, the specific questionnaire is determined to be a first questionnaire with at least one question relating to the predetermined commodity.

15. The method according to claim 11, wherein the displayed one or more questions includes a question regarding a shopping experience of the customer.

16. The method according to claim 11, wherein the one or more questions are displayed and the selection of one of the answer choices to each question is received during the transaction.

17. The method according to claim 11, further comprising:
determining whether the selection of one of the answer choices to each question is received, and
if the selection of one of the answer choices is received, determining a reward to provide the customer.

18. The method according to claim 17, wherein the reward is further determined based on whether the customer is a registered member.

19. The method according to claim 17, further comprising:
controlling a print unit to print the reward.

20. The method according to claim 17, further comprising:
receiving, via the operation panel, customer information for identifying the customer; and
transmitting the reward to an email address stored in correspondence with the received customer identification.
